(19) United States
(12) Patent Application Publication
(10) Pub. No.: US 2018/0093858 A1
(43) Pub. Date: Apr. 5, 2018

(54) METHOD FOR OCCUPANT EVACUATION OPERATION UTILIZING MULTI-COMPARTMENT ELEVATORS

(71) Applicant: Otis Elevator Company, Farmington, CT (US)

(72) Inventors: David M. Hughes, East Hampton, CT (US); James M. Collins, Burlington, CT (US); Jannah A. Stanley, Portland, CT (US); Paul A. Stranieri, Bristol, CT (US); Ronnie E. Thebeau, Haddam, CT (US)

(21) Appl. No.: 15/281,178

(22) Filed: Sep. 30, 2016

(51) Int. Cl. B66B 5/02; B66B 1/28

(52) U.S. Cl. CPC B66B 5/021; B66B 1/28

(57) ABSTRACT

A method of operating an elevator system includes: receiving an evacuation call from a first evacuation floor; determining an evacuation zone surrounding the first evacuation floor; determining a number of passengers on each floor within the evacuation zone; determining a set of adjacent floors within the evacuation zone that have a highest combined passenger number, the set of adjacent floors including a first adjacent floor and a second adjacent floor; and moving a multi-compartment elevator car to the set of adjacent floors with the highest combined passenger number, the multi-compartment elevator having a first compartment and a second compartment; wherein the first compartment arrives at the first adjacent floor and the second compartment arrives at the second adjacent floor when the multi-compartment elevator car arrives at the set of adjacent floors with the highest combined passenger number.

### BACKGROUND

The subject matter disclosed herein relates generally to the field of elevator systems, and specifically to a method and apparatus for operating an elevator system in a building evacuation.

Commonly, during an evacuation procedure occupants of a building are instructed to take the stairs and avoid the elevator systems. An efficient method of incorporating the elevators into overall evacuation procedures is desired.

### BRIEF SUMMARY

According to one embodiment, a method of operating an elevator system is provided. The method includes: receiving an evacuation call from a first evacuation floor; determining an evacuation zone surrounding the first evacuation floor; determining a number of passengers on each floor within the evacuation zone; determining a set of adjacent floors within the evacuation zone that have a highest combined passenger number, the set of adjacent floors including a first adjacent floor and a second adjacent floor; and moving a multi-compartment elevator car to the set of adjacent floors with the highest combined passenger number, the multi-compartment elevator having a first compartment and a second compartment; wherein the first compartment arrives at the first adjacent floor and the second compartment arrives at the second adjacent floor when the multi-compartment elevator car arrives at the set of adjacent floors with the highest combined passenger number.

In addition to one or more of the features described above, or as an alternative, further embodiments of the method may include that at least one of the first adjacent floor and the second adjacent is the first evacuation floor; and an elevator call has been received from the first evacuation floor.

In addition to one or more of the features described above, or as an alternative, further embodiments of the method may include: opening a first door of the first compartment and a second door of the second compartment when the multi-compartment elevator car arrives at the set of adjacent floors with the highest combined passenger number; monitoring, using a first sensor system, a remaining capacity of the first compartment; monitoring, using a second sensor system, a remaining capacity of the second compartment; closing the first door when at least one of a selected period of time has passed and the remaining capacity of the first compartment is equal to a first selected remaining capacity; and closing the second door when at least one of the selected period of time has passed and the remaining capacity of the second compartment is equal to a second selected remaining capacity.

In addition to one or more of the features described above, or as an alternative, further embodiments of the method may include moving the multi-compartment elevator car to a discharge floor when at least one of the selected period of time has passed, the remaining capacity of the first compartment is equal to about zero, and the remaining capacity of the second compartment is equal to about zero.

In addition to one or more of the features described above, or as an alternative, further embodiments of the method may include updating the number of passengers on each floor within the evacuation zone in response to the remaining capacity of the first compartment and the remaining capacity of the second compartment.

In addition to one or more of the features described above, or as an alternative, further embodiments of the method may include: updating the number of passengers on each floor within the evacuation zone in response to the remaining capacity of the first compartment and the remaining capacity of the second compartment; determining a next set of adjacent floors within the evacuation zone that have a highest combined passenger number; and moving a multi-compartment elevator car to the next set of adjacent floors with the highest combined passenger number.

In addition to one or more of the features described above, or as an alternative, further embodiments of the method may include that the number of passengers determined on each floor is a weighted number of passengers.

According to another embodiment, a controller of an elevator system is provided. The controller includes: a processor; a memory comprising computer-executable instructions that, when executed by the processor, cause the processor to perform operations. The operations includes: receiving an evacuation call from a first evacuation; determining an evacuation zone surrounding the first evacuation floor; determining a number of passengers on each floor within the evacuation zone; determining a set of adjacent floors within the evacuation zone that have a highest combined passenger number, the set of adjacent floors including a first adjacent floor and a second adjacent floor; and moving a multi-compartment elevator car to the set of adjacent floors with the highest combined passenger number, the multi-compartment elevator having a first compartment and a second compartment; wherein the first compartment arrives at the first adjacent floor and the second compartment arrives at the second adjacent floor when the multi-compartment elevator car arrives at the set of adjacent floors with the highest combined passenger number.

In addition to one or more of the features described above, or as an alternative, further embodiments of the controller may include that at least one of the first adjacent floor and the second adjacent is the first evacuation floor; and an elevator call has been received from the first evacuation floor.

In addition to one or more of the features described above, or as an alternative, further embodiments of the controller may include that the operations further included: opening a first door of the first compartment and a second door of the second compartment when the multi-compartment elevator car arrives at the set of adjacent floors with the highest combined passenger number; monitoring, using a first sensor system, a remaining capacity of the first compartment; monitoring, using a second sensor system, a remaining capacity of the second compartment; holding the first door and the second door open for a selected period of time; and closing the first door when at least one of the selected period of time has passed and the remaining capacity of the first compartment is equal to a first selected remaining capacity; and closing the second door when at least one of the selected period of time has passed and the remaining capacity of the second compartment is equal to a second selected remaining capacity.

In addition to one or more of the features described above, or as an alternative, further embodiments of the controller may include that the operations further include moving the multi-compartment elevator car to a discharge floor when at least one of the selected period of time has passed, the remaining capacity of the first compartment is equal to about zero, and the remaining capacity of the second compartment is equal to about zero.

In addition to one or more of the features described above, or as an alternative, further embodiments of the controller may include that the operations further include updating the number of passengers on each floor within the evacuation zone in response to the remaining capacity of the first compartment and the remaining capacity of the second compartment.

In addition to one or more of the features described above, or as an alternative, further embodiments of the controller may include that the operations further include: updating the number of passengers on each floor within the evacuation zone in response to the remaining capacity of the first compartment and the remaining capacity of the second compartment; determining a next set of adjacent floors within the evacuation zone that have a highest combined passenger number; and moving a multi-compartment elevator car to the next set of adjacent floors with the highest combined passenger number.

In addition to one or more of the features described above, or as an alternative, further embodiments of the controller may include that the number of passengers on each floor is determined using at least one of an executable algorithm, a look up table, and a building integrated personnel sensing system.

According to an embodiment, a computer program product tangibly embodied on a computer readable medium is provided. The computer program product including instructions that, when executed by a processor, cause the processor to perform operations. The operations include: receiving an evacuation call from a first evacuation floor; determining an evacuation zone surrounding the first evacuation floor; determining a number of passengers on each floor within the evacuation zone; determining a set of adjacent floors within the evacuation zone that have a highest combined passenger number, the set of adjacent floors including a first adjacent floor and a second adjacent floor; and moving a multi-compartment elevator car to the set of adjacent floors with the highest combined passenger number, the multi-compartment elevator having a first compartment and a second compartment; wherein the first compartment arrives at the first adjacent floor and the second compartment arrives at the second adjacent floor when the multi-compartment elevator car arrives at the set of adjacent floors with the highest combined passenger number.

In addition to one or more of the features described above, or as an alternative, further embodiments of the controller may include that: at least one of the first adjacent floor and the second adjacent is the first evacuation floor; and an elevator call has been received from the first evacuation floor.

In addition to one or more of the features described above, or as an alternative, further embodiments of the controller may include that the operations further include: opening a first door of the first compartment and a second door of the second compartment when the multi-compartment elevator car arrives at the set of adjacent floors with the highest combined passenger number; monitoring, using a first sensor system, a remaining capacity of the first compartment; monitoring, using a second sensor system, a remaining capacity of the second compartment; holding the first door and the second door open for a selected period of time; closing the first door when at least one of the selected period of time has passed and the remaining capacity of the first compartment is equal to a first selected remaining capacity; and closing the second door when at least one of the selected period of time has passed and the remaining capacity of the second compartment is equal to a second selected remaining capacity.

In addition to one or more of the features described above, or as an alternative, further embodiments of the controller may include that the operations further include moving the multi-compartment elevator car to a discharge floor when at least one of the selected period of time has passed, the remaining capacity of the first compartment is equal to about zero, and the remaining capacity of the second compartment is equal to about zero.

In addition to one or more of the features described above, or as an alternative, further embodiments of the controller may include that the operations further include updating the number of passengers on each floor within the evacuation zone in response to the remaining capacity of the first compartment and the remaining capacity of the second compartment.

In addition to one or more of the features described above, or as an alternative, further embodiments of the controller may include that the operations further include updating the number of passengers on each floor within the evacuation zone in response to the remaining capacity of the first compartment and the remaining capacity of the second compartment; determining a next set of adjacent floors within the evacuation zone that have a highest combined passenger number; and moving a multi-compartment elevator car to the next set of adjacent floors with the highest combined passenger number.

Technical effects of embodiments of the present disclosure include using a control system to send a multi-compartment elevator car to a set of adjacent floors within an evacuation zone that have a highest combined passenger number out of all adjacent floors within the evacuation zone.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the disclosure are apparent from the following detailed description taken in conjunction with the accompanying drawings in which like elements are numbered alike in the several FIGURES:

FIG. 1 illustrates a schematic view of an elevator system having a multi-compartment elevator car, in accordance with an embodiment of the disclosure;

FIG. 2 illustrates a schematic view of a building incorporating the elevator system of FIG. 1, in accordance with an embodiment of the disclosure; and

FIG. 3 is a flow chart of method of operating the elevator system of FIG. 1, in accordance with an embodiment of the disclosure.

### DETAILED DESCRIPTION

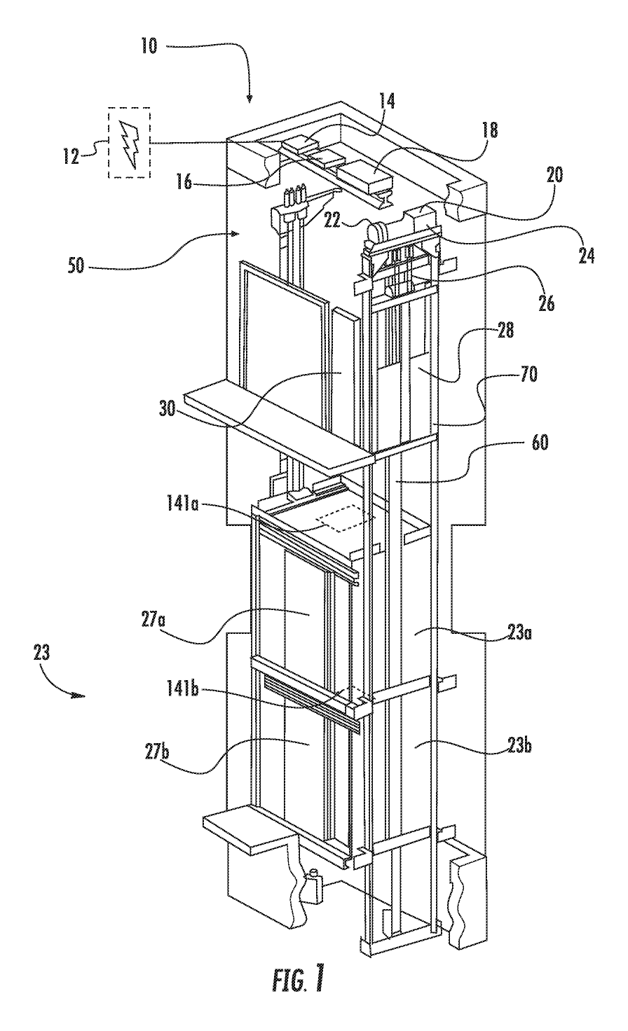

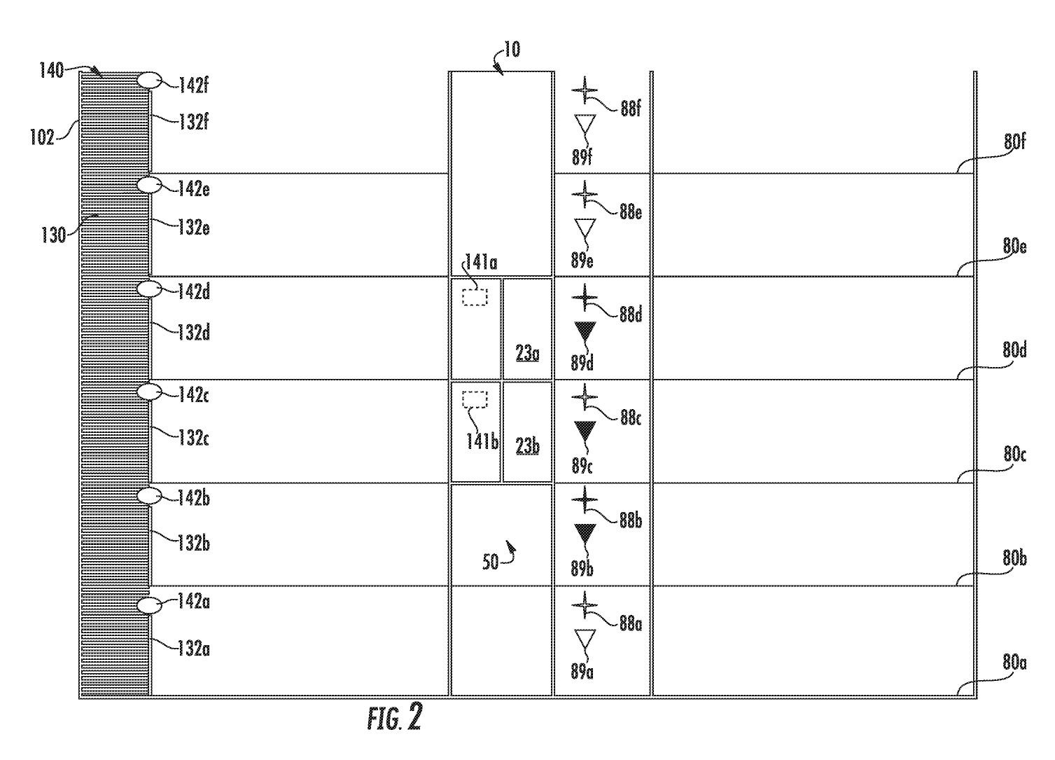

FIG. 1 shows a schematic view of an elevator system 10 having a multi-compartment elevator car 23, in accordance with an embodiment of the disclosure. FIG. 2 shows schematic view of a building 102 incorporating the elevator system 10 of FIG. 1, in accordance with an embodiment of the disclosure. With reference to FIG. 1, the elevator system 10 includes a multi-compartment elevator car 23 configured to move vertically upward and downward within a hoistway 50 along a plurality of car guide rails 60. As seen in FIG. 1, the multi-compartment elevator car 23 includes a first compartment 23a and a second compartment 23b. The first compartment 23a includes a first door 27a and the second compartment 23b includes a second door 27b. The doors 27a, 27b for each compartment 23a, 23b open and close, allowing passengers to enter and exit each compartment 23a, 23b of the multi-compartment elevator car 23. The elevator system 10 also includes a counterweight 28 operably connected to the multi-compartment elevator car 23 via a pulley system 26. The counterweight 28 is configured to move vertically upward and downward within the hoistway 50. The counterweight 28 moves in a direction generally opposite the movement of the multi-compartment elevator car 23, as is known in conventional elevator assemblies. Movement of the counterweight 28 is guided by counterweight guide rails 70 mounted within the hoistway 50.

The elevator system 10 also includes a power source 12. The power is provided from the power source 12 to a switch panel 14, which may include circuit breakers, meters, etc. From the switch panel 14, the power may be provided directly to the drive unit 20 through the controller 30 or to an internal power source charger 16, which converts AC power to direct current (DC) power to charge an internal power source 18 that requires charging. For instance, an internal power source 18 that requires charging may be a battery, capacitor, or any other type of power storage device known to one of ordinary skill in the art. Alternatively, the internal power source 18 may not require charging from the external power source 12 and may be a device such as, for example a gas powered generator, solar cells, hydroelectric generator, wind turbine generator or similar power generation device. The internal power source 18 may power various components of the elevator system 10 when an external power source is unavailable. The drive unit 20 drives a machine 22 to impart motion to the multi-compartment elevator car 23 via a traction sheave of the machine 22. The machine 22 also includes a brake 24 that can be activated to stop the machine 22 and multi-compartment elevator car 23. As will be appreciated by those of skill in the art, FIG. 1 depicts a machine room-less elevator system 10, however the embodiments disclosed herein may be incorporated with other elevator systems that are not machine room-less or that include any other known elevator configuration. In addition, elevator systems having more than one independently operating elevator car in each elevator car shaft and/or ropeless elevator systems may also be used. In one embodiment, the elevator car 23 may have three or more compartments.

The controller 30 is responsible for controlling the operation of the elevator system 10. The controller 30 may also determine a mode (motoring, regenerative, near balance) of the multi-compartment elevator car 23. The controller 30 may use the car direction and the weight distribution between the multi-compartment elevator car 23 and the counterweight 28 to determine the mode of the multi-compartment elevator car 23. The controller 30 may adjust the velocity of the multi-compartment elevator car 23 to reach a target floor. The controller 30 may include a processor and an associated memory. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The elevator system 10 includes a sensor system 141a, 141b configured to detect a remaining capacity of a particular compartment 23a, 23b of the multi-compartment elevator car 23. The remaining capacity allows the controller 30 to determine how much space is left in each elevator compartment 23a, 23b. For instance, if the remaining capacity is equal to about zero there is no space left in the elevator compartment 23a, 23b to accept more passengers, whereas if the remaining capacity is greater than zero there may be space to accept more passengers in the elevator compartment 23a, 23b. In the illustrated embodiments, the sensor system 141a, 141b includes a first sensor system 141a located in the first compartment 23a and a second sensor system 141b located in the second compartment 23b. Each sensor system 141a and 141b is in operative communication with the controller 30. The sensor systems 141a, 141b may use a variety of sensing mechanisms such as, for example, a visual detection device, a weight detection device, a laser detection device, a door reversal monitoring device, a thermal image detection device, and a depth detection device. The visual detection device may be a camera that utilizes visual recognition to identify individual passengers and objects in the elevator compartment 23a, 23b and then determine remaining capacity. The weight detection device may be a scale to sense the amount of weight in an elevator compartment 23a, 23b and then determine the remaining capacity from the weight sensed. The laser detection device may detect how many passengers walk through a laser beam to determine the remaining capacity in the elevator compartment 23a, 23b. Similarly, a door reversal monitoring device also detects passengers entering the car so as not to close the elevator door on a passenger and thus may be used to determine the remaining capacity. The thermal detection device may be an infrared or other heat sensing camera that utilizes detected temperature to identify individual passengers and objects in the elevator compartment 23a, 23b and then determine remaining capacity. The depth detection device may be a 2-D, 3-D or other depth/distance detecting camera that utilizes detected distance to an object and/or passenger to determine remaining capacity. As may be appreciated by one of skill in the art, in addition to the stated methods, additional methods may exist to sense remaining capacity and one or any combination of these methods may be used to determine remaining capacity in the elevator compartment 23a, 23b.

FIG. 2 shows a building 102 incorporating an elevator system 10 having a multi-compartment elevator car 23. The building 102 includes multiple floors 80a-80f, each having an elevator call button 89a-89f and an evacuation alarm 88a-88f. The elevator call button 89a-89f sends an elevator call to the controller 30. The elevator call button 89a-89f may be a push button and/or a touch screen and may be activated manually or automatically. For example, the elevator call button 89a-89f may be activated by a building occupant pushing the elevator call button 89a-89f. The elevator call button 89a-89f may also be activated voice recognition or a passenger detection mechanism in the hallway, such as, for example a weight sensing device, a visual recognition device, and a laser detection device. The evacuation alarm 88a-88f may be activated or deactivated either manually or automatically through a fire alarm system. If the evacuation alarm 88a-88f is activated, the evacuation call is sent to the controller 30 indicating the respective floor 80a-80f where the evacuation alarm 88a-88f was activated. In the example of FIG. 2, an evacuation alarm 88d is activated first on floor 80d and an evacuation alarm 88b is later activated on floor 80b. The evacuation alarm 88a, 88, 88e, 88f is not activated on floors 80a, 80c, 80e, and 80f. The first floor to activate an evacuation alarm may be known as the first evacuation floor. In the example of FIG. 2, the first evacuation floor is floor 80d. The second evacuation floor to activate an evacuation alarm may be known as the second evacuation floor and so on.

The first evacuation floor may be surrounded by padding floors, which are floors that are considered at increased risk due to their proximity to the evacuation floor and thus should also be evacuated. In the example of FIG. 2, the padding floors for the first evacuation floor are floors 80b, 80c, 80e, and 80f. The padding floors may include floors that are a selected number of floors away from the first evacuation floor. In one embodiment, the padding floors may include any number of floors on either side of an evacuation floor. For example, in one embodiment, the padding floors may include the floor immediately below the evacuation floor and the three floors immediately above the evacuation floor. In another example, in one embodiment, the padding floors may include the two floors immediately below the evacuation floor and the two floors immediately above the evacuation floor. The first evacuation floor and the padding floors make up an evacuation zone. In the example of FIG. 2, the evacuation zone is composed of floors 80b-80f.

In one embodiment, there may be more than one evacuation floor. For example, after the first evacuation floor activates an evacuation alarm, a second evacuation floor may also activate an evacuation alarm. In the example of FIG. 2, the second evacuation floor is floor 80b. In one embodiment, there may be any number of evacuation floors. Evacuation floors may be evacuated in the order that the evacuation call is received. Padding floors of the first evacuation floor may be evacuated before the second evacuation floor. In one embodiment, all evacuation floors may be evacuated first, followed by padding floors associated with each evacuation floor in the order in which the corresponding evacuation call was placed. Although in the embodiment of FIG. 2 the second evacuation floor is contiguous to the padding floors of the first evacuation floor, the second evacuation floor and any subsequent evacuation floors may be located anywhere within the building. The building also includes a discharge floor, which is a floor where occupants can evacuate the building 102. For example, in one embodiment the discharge floor may be a ground floor. In one embodiment, the discharge floor may be any floor that permits an occupant to evacuate the building. In the example of FIG. 2, the discharge floor is floor 80a. The building may also include a stairwell 130 as seen in FIG. 2.

The controller 30 is configured to determine how many passengers are on a particular floor 80a-80f. The controller 30 may determine how many passengers are on a particular floor 80a-80f using an executable algorithm and/or a look up table that may be stored within the memory of the controller 30. The look up table may contain predicted number for how many passengers are on each floor 80 on a particular date at a particular time. For example, the predicted number of passenger may be more for a day during the work week then a day on the weekend. In one embodiment, this data may be provided into the system by a building manager, tenants, or businesses located in the building 102. For example, the data could include a number of employees employed at a business on a particular floor of the building 102 and the expected working hours and days of those employees. In one embodiment, expected working hours and days could be entered for each employee. The data may be input when the system is first commissioned or updated at periodic intervals as desired.

The controller 30 may also determine how many passengers are on a particular floor 80a-80f using a building integrated personnel sensing system 140 composed a plurality of sensors throughout the building 102 configured to detect a number of passengers on each floor 80a-80f. The building integrated personnel sensing system 140 may count the number of passengers entering and exiting each floor 80a-80f using a stairwell door sensors 142a-142f and also the sensor systems 141a, 141b. In one embodiment, the number of personnel on a particular floor may be determined by using security access control data (and corresponding floor access permissions/information) as personnel scan their credentials as they enter the building.

The stairwell door sensor 142a-142f counts the number of passengers entering and exiting the respective stairwell door 132a-132f. The stairwell door sensor 142a-142f may use a variety of sensing mechanisms such as, for example, a visual detection device, a weight detection device, a laser detection device, a thermal image detection device, and a depth detection device. The visual detection device may be a camera that utilizes visual recognition to identify and count individual passengers entering and exiting a particular floor 80a-80f from the stairwell 130. The weight detection device may be a scale to sense the amount of weight in an area proximate the stairwell door 132a-132f and then determine the number of passengers entering and exiting the particular floor 80a-80f from the weight sensed. The laser detection device may detect how many passengers walk through a laser beam located proximate the stairwell door 132a-132f to determine the number of passengers entering and exiting a floor 80a-80f. The thermal detection device may be an infrared or other heat sensing camera that utilizes detected temperature to identify how many passengers are located proximate the stairwell door 132a-132f to determine the number of passengers entering and exiting a floor 80a-80f. The depth detection device may be a 2-D, 3-D or other depth/distance detecting camera that utilizes detected distance to a passenger to determine how many passengers are located proximate the stairwell door 132a-132f to determine the number of passengers entering and exiting a floor 80a-80f. The stairwell door sensor 142a-142f interacts with the sensor systems 141a, 141b to determine the number of passengers on each floor 80a-80f. As may be appreciated by one of skill in the art, in addition to the stated methods, additional methods may exist to sense passengers and one or any combination of these methods may be used to determine the number of passengers entering and exiting a floor 80a-80f.

Advantageously, by tracking the number of passengers entering or exiting a floor 80a-80f, when an evacuation call is received from a first evacuation floor, the controller 30 could quickly identify the evacuation zone and then identify a set of adjacent floors having the most passengers to make efficient use of the multi-compartment elevator car 23. Adjacent floors are two floors next to each other within the evacuation zone. In an embodiment, in order to determine which floor has the most passengers, the passengers are counted by the number of passengers located on the entire floor. In another embodiment, in order to determine which floor has the most passengers, the passengers are counted by the number of passengers located proximate the hoistway 50 on each floor 80a-80f. In one embodiment, personnel's access control information for security may include an indication of whether they may need to use the elevators for an evacuation rather than the stairs. For example, personnel may be able to indicate a disability that prevents them from using the stairs, a preference for using the elevators, or a preference for using the stairs in the event of an evacuation. In one embodiment, this information may be stored in the lookup table discussed above. In response to this data, the system could weigh the passenger count numbers of passengers requiring the elevator to evacuate higher than those who would merely prefer the elevator or those who would prefer to take the stairs. In one embodiment, those who require the elevator could count as 2 people in the determination, those who prefer the elevator as 1.5 people, and those who prefer the stairs as 1 person. It should be appreciated that any other desired weightings may be applied. The determination of which floors had the most passengers could then be made based upon this weighted number of passengers.

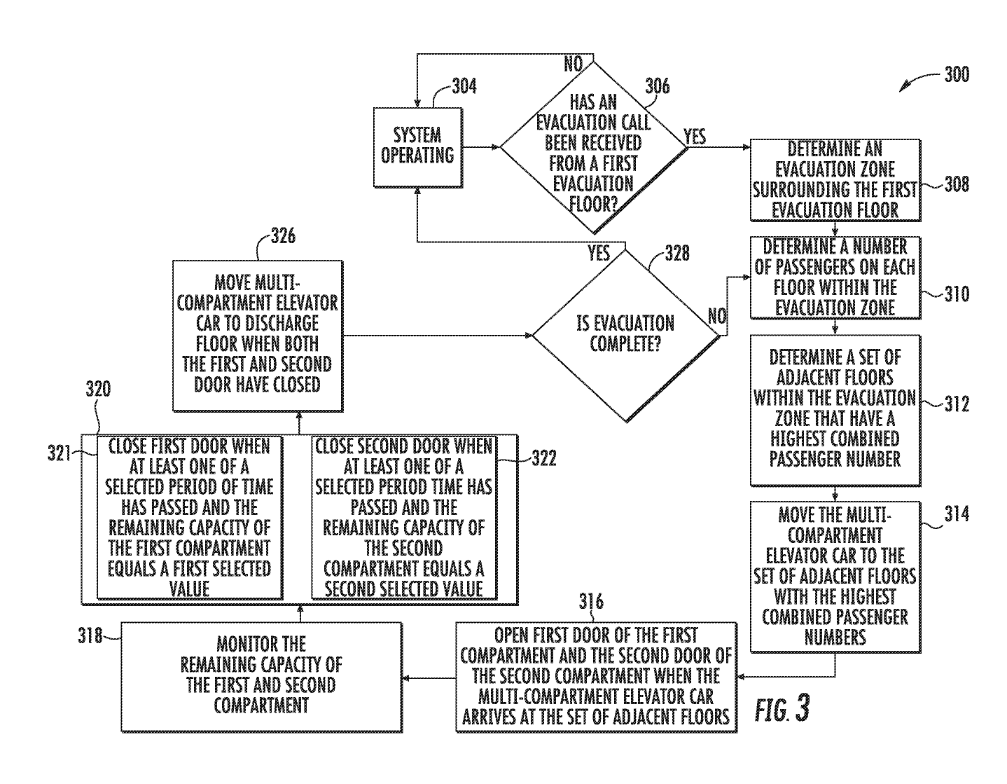

Referring now to FIG. 3, while referencing components of FIGS. 1 and 2. FIG. 3 shows a flow chart of method 300 of operating the multi-compartment elevator system 10 of FIG. 1, in accordance with an embodiment of the disclosure. At block 304, the elevator system 10 is under normal operation. At block 306, the controller 30 checks whether it has received an evacuation call from the first evacuation floor. At block 306, if the controller 30 has received an evacuation call from the first evacuation floor then the controller 30 determines an evacuation zone surrounding the first evacuation floor at block 308. As mentioned above, the evacuation zone includes the first evacuation floor and a select number of padding floors around the first evacuation floor.

At block 310, the controller 30 determines a number of passengers on each floor within the evacuation zone. In an alternative embodiment, the controller 30 may require that at least one of the adjacent floors be the first evacuation floor. In an alternative embodiment, the controller 30 may require that an elevator call has been received from both adjacent floors in order to ensure there are still passengers on the floors. In one embodiment, the determination of which floors are evacuated first may be made on any number of factors, including which floor placed an evacuation call first, provided that passenger count at least plays some role in determining which floor one of the elevator cabs stops at. As mentioned above, the number of passengers on each floor within the evacuation zone may be determined by at least one of an executable algorithm, look up table, and a building integrated personnel sensing system 140. Next at block 312, the controller 30 determines a set of adjacent floors within the evacuation zones that have a highest combined passenger number. The adjacent floors include a first adjacent floor and a second adjacent floor. In the event that there is an active call from the first evacuation floor (i.e., that a passenger on the first evacuation floor has placed an evacuation call or the system has determined that there are people on the first evacuation floor and automatically placed an evacuation call), the controller 30 may require that one of the adjacent floors be the first evacuation floor and/or a padding floor. Then at block 314, the controller 30 moves the multi-compartment elevator car to the set of adjacent floors with the highest combined passenger number. Advantageously, evacuating the set of adjacent floors with the highest combine passenger number an efficient method to utilize the multi-compartment car 23 to evacuate the building 102. The first compartment 23a arrives at the first adjacent floor and the second compartment 23b arrives at the second adjacent floor when the multi-compartment elevator car 23 arrives at the set of adjacent floors with the highest combined passenger number.

Once the multi-compartment elevator car 23 arrives at the set of adjacent floors, the controller 30 opens the first door 27a of the first compartment 23a and the second door 27b of the second compartment 23b at block 316. At block 318, the first sensor system 141a monitors the remaining capacity in the first compartment 23a and the second sensor system 141b monitors the remaining capacity in the second compartment 23b. Next, the method 300 moves onto block 320, which simultaneously carries out both block 321 and block 322. At block 321, the first door 27a is held open by the controller 30 until at least one of a selected period of time has passed and the remaining capacity in the first compartment 23a equals a first selected remaining capacity. For instance, the first selected remaining capacity may be a maximum capacity of the first compartment 23a. At block 322, the second door 27b is held open by the controller 30 until at least one of the selected period of time has passed and the remaining capacity in the second compartment 23b equals a second selected remaining capacity. The selected period of time may be enough time to allow passengers to fill the remaining capacity of the respective compartment 23a, 23b, such as, for example ten seconds. In one embodiment, the selected period of time may be more or less than ten seconds. The selected period of time may change in response to many factors including the remaining capacity of the respective compartment and thus there may be a first selected period of time, a second selected period of time, a third selected period of time, and so on to account for the variations the time required to load passengers at each floor. The selected remaining capacity may be a maximum capacity of the respective compartment 23a, 23b (ex: the maximum capacity is when the remaining capacity is equal to about zero) or the selected remaining capacity may be the remaining capacity of the respective compartment 23a, 23b after a known number of passengers on the floor have entered the respective compartment 23a, 23b. There may be a second selected remaining capacity, a third selected remaining capacity, and so on.

Once the first door 27a and the second door 27b are closed, then the controller 30 moves the multi-compartment elevator car 23 to the discharge floor at block 326. At the discharge floor, the passengers could exit the multi-compartment elevator car 23 and then exit the building 102. Once the multi-compartment elevator car 23 has zero passengers in each compartment 23a, 23b or a selected period of time has passed then the controller will determine whether the evacuation is complete at block 328. At block 328, if the evacuation is complete, then the controller 30 will return the elevator system 10 back to block 304 for normal operation. The evacuation may be considered complete when all passengers have exited the building 102. At block 328, if the evacuation is not complete, then the controller 30 will return the elevator system 10 back to block 310 to re-determine the number of passengers on each floor within the evacuation zone. The controller 30 will take into account how many passengers were already evacuated when re-determining the number of passenger on each floor within the evacuation zone at block 310. Next, the method 300 will move back to block 312 and through the rest of the method 300 to evacuate a next set of adjacent floors having the highest combined number of passengers.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting. While the description has been presented for purposes of illustration and description, it is not intended to be exhaustive or limited to embodiments in the form disclosed. Many modifications, variations, alterations, substitutions or equivalent arrangement not hereto described will be apparent to those of ordinary skill in the art without departing from the scope of the disclosure. Additionally, while the various embodiments have been described, it is to be understood that aspects may include only some of the described embodiments. Accordingly, the disclosure is not to be seen as limited by the foregoing description, but is only limited by the scope of the appended claims.

What is claimed is:

1. A method of operating an elevator system, the method comprising:
receiving an evacuation call from a first evacuation floor;
determining an evacuation zone surrounding the first evacuation floor;
determining a number of passengers on each floor within the evacuation zone;
determining a set of adjacent floors within the evacuation zone that have a highest combined passenger number, the set of adjacent floors including a first adjacent floor and a second adjacent floor; and
moving a multi-compartment elevator car to the set of adjacent floors with the highest combined passenger number, the multi-compartment elevator having a first compartment and a second compartment;
wherein the first compartment arrives at the first adjacent floor and the second compartment arrives at the second adjacent floor when the multi-compartment elevator car arrives at the set of adjacent floors with the highest combined passenger number.

2. The method of claim 1, wherein:
at least one of the first adjacent floor and the second adjacent is the first evacuation floor; and
an elevator call has been received from the first evacuation floor.

3. The method of claim 1, further comprising:
opening a first door of the first compartment and a second door of the second compartment when the multi-compartment elevator car arrives at the set of adjacent floors with the highest combined passenger number;
monitoring, using a first sensor system, a remaining capacity of the first compartment; monitoring, using a second sensor system, a remaining capacity of the second compartment;
closing the first door when at least one of a selected period of time has passed and the remaining capacity of the first compartment is equal to a first selected remaining capacity; and
closing the second door when at least one of the selected period of time has passed and the remaining capacity of the second compartment is equal to a second selected remaining capacity.

4. The method of claim 3, further comprising:
moving the multi-compartment elevator car to a discharge floor when at least one of the selected period of time has passed, the remaining capacity of the first compartment is equal to about zero, and the remaining capacity of the second compartment is equal to about zero.

5. The method of claim 3, further comprising:
updating the number of passengers on each floor within the evacuation zone in response to the remaining capacity of the first compartment and the remaining capacity of the second compartment.

6. The method of claim 4, further comprising:
updating the number of passengers on each floor within the evacuation zone in response to the remaining capacity of the first compartment and the remaining capacity of the second compartment;
determining a next set of adjacent floors within the evacuation zone that have a highest combined passenger number; and
moving a multi-compartment elevator car to the next set of adjacent floors with the highest combined passenger number.

7. The method of claim 1, wherein:
the number of passengers determined on each floor is a weighted number of passengers.

8. A controller of an elevator system comprising:
a processor;
a memory comprising computer-executable instructions that, when executed by the processor, cause the processor to perform operations, the operations comprising:
receiving an evacuation call from a first evacuation;
determining an evacuation zone surrounding the first evacuation floor;
determining a number of passengers on each floor within the evacuation zone;
determining a set of adjacent floors within the evacuation zone that have a highest combined passenger number, the set of adjacent floors including a first adjacent floor and a second adjacent floor; and
moving a multi-compartment elevator car to the set of adjacent floors with the highest combined passenger number, the multi-compartment elevator having a first compartment and a second compartment;
wherein the first compartment arrives at the first adjacent floor and the second compartment arrives at the second adjacent floor when the multi-compartment elevator car arrives at the set of adjacent floors with the highest combined passenger number.

9. The controller of claim 8, wherein:
at least one of the first adjacent floor and the second adjacent is the first evacuation floor; and
an elevator call has been received from the first evacuation floor.

10. The controller of claim 8, wherein the operations further comprise:
opening a first door of the first compartment and a second door of the second compartment when the multi-compartment elevator car arrives at the set of adjacent floors with the highest combined passenger number;
monitoring, using a first sensor system, a remaining capacity of the first compartment;
monitoring, using a second sensor system, a remaining capacity of the second compartment;
holding the first door and the second door open for a selected period of time;
closing the first door when at least one of the selected period of time has passed and the remaining capacity of the first compartment is equal to a first selected remaining capacity; and
closing the second door when at least one of the selected period of time has passed and the remaining capacity of the second compartment is equal to a second selected remaining capacity.

11. The controller of claim 10, wherein the operations further comprise:
moving the multi-compartment elevator car to a discharge floor when at least one of the selected period of time has passed, the remaining capacity of the first compartment is equal to about zero, and the remaining capacity of the second compartment is equal to about zero.

12. The controller of claim 10, wherein the operations further comprise:
updating the number of passengers on each floor within the evacuation zone in response to the remaining capacity of the first compartment and the remaining capacity of the second compartment.

13. The controller of claim 11, wherein the operations further comprise:
updating the number of passengers on each floor within the evacuation zone in response to the remaining capacity of the first compartment and the remaining capacity of the second compartment;
determining a next set of adjacent floors within the evacuation zone that have a highest combined passenger number; and
moving a multi-compartment elevator car to the next set of adjacent floors with the highest combined passenger number.

14. The controller of claim 8, wherein:
the number of passengers on each floor is determined using at least one of an executable algorithm, a look up table, and a building integrated personnel sensing system.

15. A computer program product tangibly embodied on a computer readable medium, the computer program product including instructions that, when executed by a processor, cause the processor to perform operations comprising:
receiving an evacuation call from a first evacuation floor;
determining an evacuation zone surrounding the first evacuation floor;
determining a number of passengers on each floor within the evacuation zone;
determining a set of adjacent floors within the evacuation zone that have a highest combined passenger number, the set of adjacent floors including a first adjacent floor and a second adjacent floor; and
moving a multi-compartment elevator car to the set of adjacent floors with the highest combined passenger number, the multi-compartment elevator having a first compartment and a second compartment;
wherein the first compartment arrives at the first adjacent floor and the second compartment arrives at the second adjacent floor when the multi-compartment elevator car arrives at the set of adjacent floors with the highest combined passenger number.

16. The computer program of claim 15, wherein:
at least one of the first adjacent floor and the second adjacent is the first evacuation floor; and
an elevator call has been received from the first evacuation floor.

17. The computer program of claim 15, wherein the operations further comprise:
opening a first door of the first compartment and a second door of the second compartment when the multi-compartment elevator car arrives at the set of adjacent floors with the highest combined passenger number;
monitoring, using a first sensor system, a remaining capacity of the first compartment;
monitoring, using a second sensor system, a remaining capacity of the second compartment;
holding the first door and the second door open for a selected period of time;
closing the first door when at least one of the selected period of time has passed and the remaining capacity of the first compartment is equal to a first selected remaining capacity; and
closing the second door when at least one of the selected period of time has passed and the remaining capacity of the second compartment is equal to a second selected remaining capacity.

18. The computer program of claim 17, wherein the operations further comprise:
moving the multi-compartment elevator car to a discharge floor when at least one of the selected period of time has passed, the remaining capacity of the first compartment is equal to about zero, and the remaining capacity of the second compartment is equal to about zero.

19. The computer program of claim 17, wherein the operations further comprise:
updating the number of passengers on each floor within the evacuation zone in response to the remaining capacity of the first compartment and the remaining capacity of the second compartment.

20. The computer program of claim 18, wherein the operations further comprise:
updating the number of passengers on each floor within the evacuation zone in response to the remaining capacity of the first compartment and the remaining capacity of the second compartment;
determining a next set of adjacent floors within the evacuation zone that have a highest combined passenger number; and
moving a multi-compartment elevator car to the next set of adjacent floors with the highest combined passenger number.
